(19) United States
(12) Patent Application Publication
(10) Pub. No.: US 2022/0409453 A1
(43) Pub. Date: Dec. 29, 2022

(54) MOTORIZED WHEELCHAIR WITH ADJUSTMENT AND COMPACTION SYSTEM AND ATTACHABLE OFF-ROAD KIT WITH ASSEMBLY SYSTEM

(71) Applicant: GREEN INNOVATION INDÚSTRIA DE EQUIPAMENTOS MÉDICOS LTDA., SANTA CATARINA (BR)

(72) Inventor: LUIZ ARMANDO NICOLAO, SANTA CATARINA (BR)

(21) Appl. No.: 17/847,891

(22) Filed: Jun. 23, 2022

(30) Foreign Application Priority Data
Jun. 29, 2021 (BR) 1020210129166

(51) Int. Cl. A61G 5/04; A61G 5/08

(52) U.S. Cl. CPC A61G 5/046; A61G 5/042; A61G 5/045; A61G 5/08; A61G 2203/14; A61G 2203/20

(57) ABSTRACT

A motorized wheelchair controlled by electronic control, equipped with a structure adapted to receive a series of quick adjustments and an off-road kit to allow its locomotion through differentiated, rough and inhospitable terrains. Said wheelchair is formed by a tubular metallic structure composed of a seat structure, backrest structure, armrest and lower support structure equipped with a front wheel and rear wheel. The off-road kit consists of a pair of rear wheels with off-road or mixed tires equipped with their own rotating motor, and a pair of front wheels with off-road or mixed tires, being such wheels engaged and fixed to the chair, easily and quickly replacing the original ones.

### FIELD OF THE INVENTION

The present invention relates to a motorized wheelchair equipped with a series of adjustments for better use and a compaction system to reduce its volume in order to facilitate its transport and storage.

The chair is designed to receive an off-road kit consisting of a pair of rear wheels and a pair of front off-road wheels, attachable to the chair, which will allow the user to access uneven, differentiated and inhospitable terrain.

All adjustments, systems and installation of the kit are carried out quickly and easily by the innovative construction of the chair's structure, allowing the user (with special needs) and/or his assistant to carry it out without the help of another person.

### BACKGROUND OF THE INVENTION

As is well known, the wheelchair helps in the process of promoting the rehabilitation, with greater independence, of people with reduced mobility, disabilities or the elderly. Guidance and indication for use must be made by a qualified professional, as well as the necessary adaptations for postural correction. Choosing the ideal type is also essential for the wheelchair user to have quality of life and well-being for everyday activities with less mobility restrictions.

As examples of current wheelchairs, equipped with innovations aimed at improving the life of the user, and as examples of the state of the art, the following documents can be mentioned:
BR 2020190228089, entitled “DISPOSITION APPLIED IN ELECTRIC WHEELCHAIR” (in free translation), which claims an electric wheelchair for transporting patients or people with special needs, whose propulsion and power system are discreetly positioned under the seat, supported on a height-adjustable support by means of rods, propulsion and power system conditioned in a single fairing that derives, in the upper part, from a rectangular prismatic, where the battery bank is, to a cylindrical shape where it is located an electric motor, centrally connected to the axle of the electric wheelchair's rear wheels, which is operated by a person through acceleration and braking commands, located on the rear handle;
BR 1020190139889, entitled “MODULAR WHEELCHAIR” (in free translation) and which claims a modular wheelchair that contains in its parts a dimension adjustment system. These systems contain uniformly spaced orifices in their parts that allow the addition of concentric tubes inside the device's tubes, in order to allow its activation from the addition of new parts and the lateral movement of internal concentric tubes;
BR 2020170228652, entitled “DEVICE FOR ATTACHING A WHEELCHAIR TO A BICYCLE” (in free translation), which claims a device to attach a wheelchair to a bicycle, formed by a mechanical set with right grip and left grip with double hollow cutouts for seat belt passage four-point closed by hitch; slightly triangular and articulated side wall fixed to the mobile plate mounted on the fixed base of the gripper fitting mounted on the fixed tube of the rod fixing bracket with through slots and upper bend and lower bend that on the inside accommodates the bushings mounted on a descending scale of diameters.

Despite the excellent application of existing products today, such as the chairs and devices listed above, the inventor sees a need to better adapt the chair to the individual anatomy of each user. In addition, there is a need for greater autonomy of the chair's adjustments and systems that can be made by the user, who is unable to perform them and depends on other people even for simple adjustments.

In addition, the main difficulty for users is the access to places not prepared to receive a wheelchair. It is known that a wheelchair user will not be able to move on rough, irregular, flooded or inhospitable terrain without the help of other people or external solutions.

Despite the examples above, even in places with daily circulation of wheelchair users, such as public transport, public roads, supermarkets and others, there are irregularities in the floor, steps or small barriers, making access difficult or impossible. There is still no solution on the market that allows the wheelchair user to move freely, with the same wheelchair, in different types of places and terrains.

Finally, it is known that a wheelchair, especially a motorized one, has great weight and volume, making it difficult to transport and store, making these simple tasks often impossible.

### BRIEF SUMMARY OF THE INVENTION

Precisely in order to alleviate or solve the problems found in the state of the art, and attentive to the needs of people with reduced mobility, the inventor presents a motorized wheelchair with several positioning adjustment systems for its parts, in addition to a compaction and removal system of the motorized wheel and an off-road type kit installation.

All adjustments are designed to be carried out quickly and simply, thanks to the chair's construction, which eliminates the need for assistance by a specialized person.

The compaction system considerably reduces the total volume of the chair, which can thus be easily inserted into smaller spaces, such as small trunks, closets and others, promoting the possibility of easy transport and storage.

The motorized wheel removal system considerably reduces the weight of the chair as well as its volume. Motorized wheels can be removed and reinstalled by simple steps and without the need for a specialized person.

The installation of the off-road kit designed especially for this chair transforms it into a mobility vehicle capable of accessing and crossing places with uneven, rough or inhospitable ground that have small barriers such as rocks or holes. This installation is designed to be carried out by an ordinary person, without the need for someone specialized, and in a quick and intuitive way.

So, the wheelchair and the off-road kit aim to bring the person with reduced mobility new possibilities of access to places that were hitherto impossible to get around and the autonomy to make the necessary adjustments for their comfort without the need for a person trained to such. In addition to bringing new possibilities for transport and storage of the chair.

### BRIEF DESCRIPTION OF THE DRAWINGS

FIG. 1—isometric view of the wheelchair with its components for the adjustment and compaction system.

FIG. 2—side view of the wheelchair with its components for the adjustment and compaction system.

FIG. 3—rear perspective view of the wheelchair with its components for adjustment and compaction system.

FIG. 4A—side photo of the wheelchair.

FIG. 4B—detail view of the electronic control of the wheelchair, as shown in the previous figure.

FIG. 4C—top view, in detail, showing the main commands of the electronic control as shown in the previous figure.

FIG. 5—isometric view of the attachable off-road kit.

FIG. 6A—side view of the wheelchair where the armrest height adjustment is performed.

FIG. 6B—sequence in detail of the adjustment components as shown in the previous figure.

FIG. 7A—side view of the wheelchair where the tilt adjustment of the backrest structure is performed.

FIG. 7B—detail sequence in rear view of the components that allow the adjustment shown in the previous figure.

FIG. 8—rear perspective view of the wheelchair with its rear wheels removed to show its coupling by threaded pins.

FIG. 9A—side view of the wheelchair in sequence of its structure's compaction.

FIG. 9B—sequence in detail, in rear view of the chair, showing the action applied to its components that allows the compaction of its structure.

FIG. 10—sequence in isometric view showing the compaction of the wheelchair.

FIG. 11A—sequence in rear perspective showing the coupling of the rear wheels of the off-road kit.

FIG. 11B—detail view of the mechanical components of the rear wheel for its coupling, as shown in the previous figure.

FIG. 12A—sequence showing the coupling of the front wheels of the off-road kit.

FIG. 12B—detail view of the mechanical components of the front wheel for its coupling as shown in the previous figure.

FIG. 13—side view of the wheelchair with the complete off-road kit attached to its structure.

### DETAILED DESCRIPTION OF THE INVENTION

Therefore, in accordance with the above, the “MOTORIZED WHEELCHAIR WITH ADJUSTMENT AND COMPACTION SYSTEM AND ATTACHABLE OFF-ROAD KIT WITH ASSEMBLY SYSTEM”, the purpose of this patent application, is a motorized wheelchair (1) controlled by electronic control, which has a structure adapted to receive a series of quick adjustments and an off-road kit (2) to allow its locomotion through differentiated, rough and inhospitable terrains.

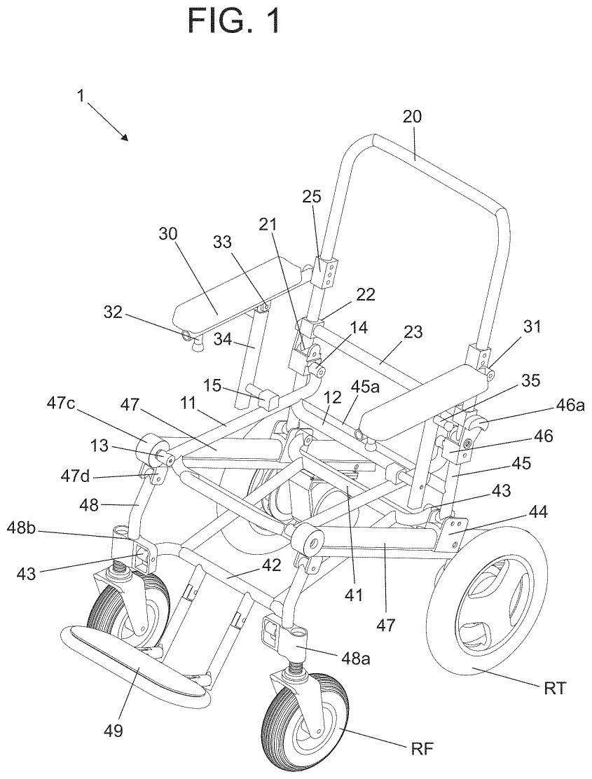

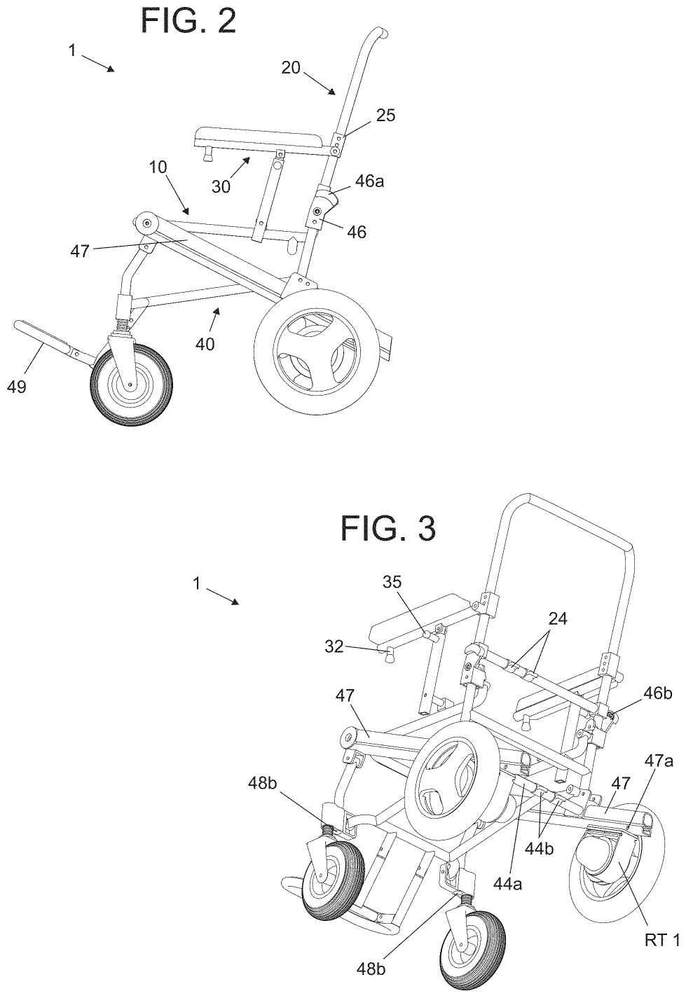

The wheelchair (1), as shown in FIGS. 1 to 4A, is formed by a tubular metallic structure composed of:
a) seat structure (10), formed by a pair of parallel side tubes (11) joined by welding to a pair of perpendicular tubes (12).

Each parallel tube (11) adopts a front eye (13) at its front end, a rear eye (14) at its rear end, and an intermediate bearing (15);
b) backrest structure (20), formed by an inverted U-bent tube whose ends adopt an eyelet (21) each. A little above each eyelet (21), the backrest structure (20) receives a pair of union terminals (22) that support a crossbar (23) equipped with pressure locks (24) whose locking pins laterally cross the backrest structure (20). Above the union terminals (22), approximately in the center of the parallel arms of the U-tube of the structure, it receives an opposing pair of adjustment terminals (25) hollowed out by three holes (may adopt a greater or lesser number of holes);
c) armrest (30), being two identical and opposing structures, positioned one on each side of the chair (1). Each armrest (30) is formed by a horizontal tubular arm, the rear end of which receives an eye (31) with which it is fixed by axis to one of the holes in one of the adjustment terminals (25) of the backrest structure (20), allowing tilting movement. Each tubular arm receives a lower locking pin (32) near its front end and a lower bearing (33) in its central portion. The lower bearing (33) supports the end of a telescopic component (34) for height adjustment, provided with a locking pin (35) and lowerly connected by shaft to the intermediate bearing (15) of the seat structure (10). In one of the tubular arms is inserted and locked by the lower locking pin (32) the support for an electronic control (36), which can be removed to be fitted in the opposite arm, when necessary; and
d) lower support structure (40), formed by a tubular frame joined by a rear tube (41) and a front tube (42), both curved in C and provided with an eye (43) at each end. The rear tube (41) has each opposing eye (43) fixed by axis to the bearing of a trolley (44), which by axis said bearing supports the eye of a vertical support bar (45), being the opposed pair of bars (45) joined and secured centrally by a crossbar (45a). The upper end of each vertical bar (45) adopts a union terminal (46) composed of two independent bearings (one lower and one upper) and a side ratchet (46a) with five housings (46b). The lower bearing receives and fixes the rear eye (14) of the parallel tube (11) of the seat structure (10) on both sides, joining it in a tilting manner to the lower support structure (40). The upper bearing, on the other hand, fixes the eyelet (21) of the backrest structure (20) on each side, joining it equally in a tilting way. In this position, the pins of the pressure locks (24) of the crossbar (23) are housed in one of the housings (46b) of the side ratchet (46a), supporting the backrest structure (20) in the vertical position. In this way, the seat structure (10) and the backrest structure (20) are hingedly joined to the lower support structure (40). The pair of opposing trolleys (44) are joined by a beam (44a) provided with pressure locks (44b) whose locking pins point inside the trolleys (44). Said trolleys (44) are slidably fitted to a pair of inclined rail-profiles (47), which receive, near each rear-end, a lower housing (not shown) with a side hole (47a) for a threaded pin (47b) and, next to each front end is an eye (47c) that joins the rail-profile (47) to the front eye (13) of the seat structure (10) by axis. Next to the eye (47c), each rail-profile (47) incorporates a lower bearing (47d) that fixes a vertical tubular profile (48) supported by a coupling terminal (48a) in its own housing (48b), which receives the front wheel (RF) of the chair and is connected by axis to the eye (43) of the front tube (42). Centrally, the front tube (42) extends a pair of arms that support an articulated and adjustable footrest (49) by axis. The lower support structure (40) also supports in its lower portion the rechargeable battery and the electronic control center (not shown).

Finally, the chair (1) receives the rear wheels (RT), which have their own electric motor with a plug for electrical supply connected to the rechargeable battery (not shown) of the chair (1). Each rear wheel (RT) has its axis of rotation supported by a bearing (RT1) whose bearing surface adopts a coupling key (RT2) coincident with the lower housing (not shown) of the rails (44) of the support structure (40). In these housings, therefore, the rear wheels (RT) are removable and then locked by the threaded pin (47b), inserted in the lateral hole (47a) of the rail (47) that supports it.

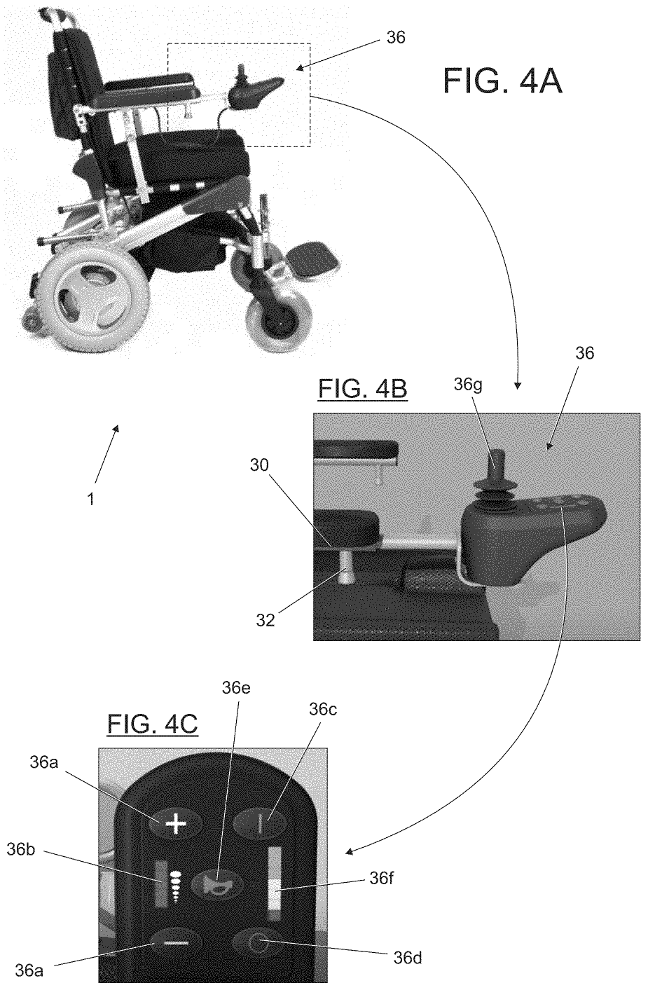

The electronic control (36) {FIGS. 4B and 4C} that controls the wheelchair (1) has at least power increase and decrease commands (36a) with LED display (36b), on (36c) and off (36d) button, horn (36e), battery charge LED display (36f) and the ‘joystic’ (36g) or control of the chair's movements and acceleration.

Optionally, together with the electronic control (36), the wheelchair (1) can have a remote control and/or an application for smartphones communicating with its electronic control center to control the wheelchair (1) remotely.

As can be seen, the attached drawings only illustrate the structure of the wheelchair (1), however it will be finished with padded seat, backrest and armrest after its manufacture.

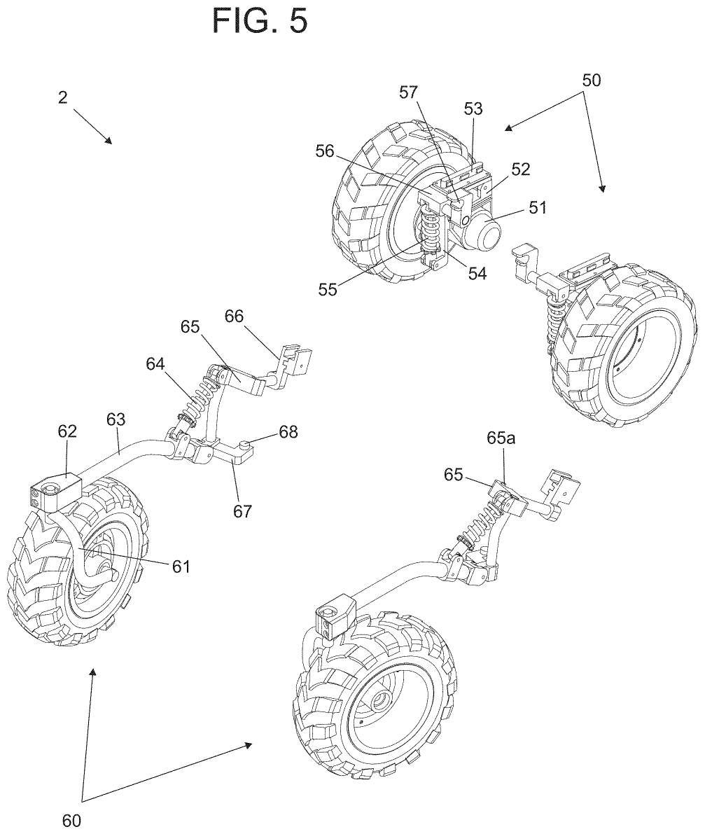

The off-road kit (2), as shown in FIG. 5, is made up of:
a) A pair of rear wheels (50), each consisting of a wheel with off-road or mixed tire, equipped with its own rotation motor, wrapped and protected by a rigid cover (51) housed in a bearing (52). From one end, the bearing (52) receives by axis a metal plate where a coupling key (53) is fixed, this one coincident with the shape of the lower housing of the rails (47) of the lower support structure (40) of the chair (1). Frontally, the bearing (52) incorporates a front support (54) where a damper assembly (55) is installed, whose upper damping terminal (56) is welded to the front face of the metal plate containing the coupling key (53) and extends, laterally, a support sleeve (57). Each off-road rear wheel (50) extends from its motor an electrical power cable provided with a connection plug coincident with the wheelchair's battery cable plug (1); and
b) A pair of front wheels (60), each consisting of a wheel with off-road or mixed tire, whose axle is connected to the tubular arm (61) of a structural chassis that supports, above the wheel, an axle connected to the bearing (62) of an extension arm (63) which, in turn, is bearing in a damper assembly (64). The latter is attached to a support that extends a joint piece (65) with a recess (65a) above and that extends a clamp-type terminal (66) provided with a latch and, below, a lateral extension (67) provided with a male pin (68) coincident with the housing (48b) of the coupling terminal (48a) of the chair (1).

The configuration of the off-road kit (2), therefore, features independent suspension on four wheels and also comes with a sports seat belt to adapt to the chair, an additional battery and a cover for storing and transporting the kit when not in use (these items are not shown in the drawings).

Thus defined, wheelchair (1) and off-road kit (2), their operating systems and methods of use are now described.

The wheelchair (1), in addition to being motorized, has several adjustment systems due to the articulated union of its various structures (10, 20, 30 and 40) through eyes and axles.

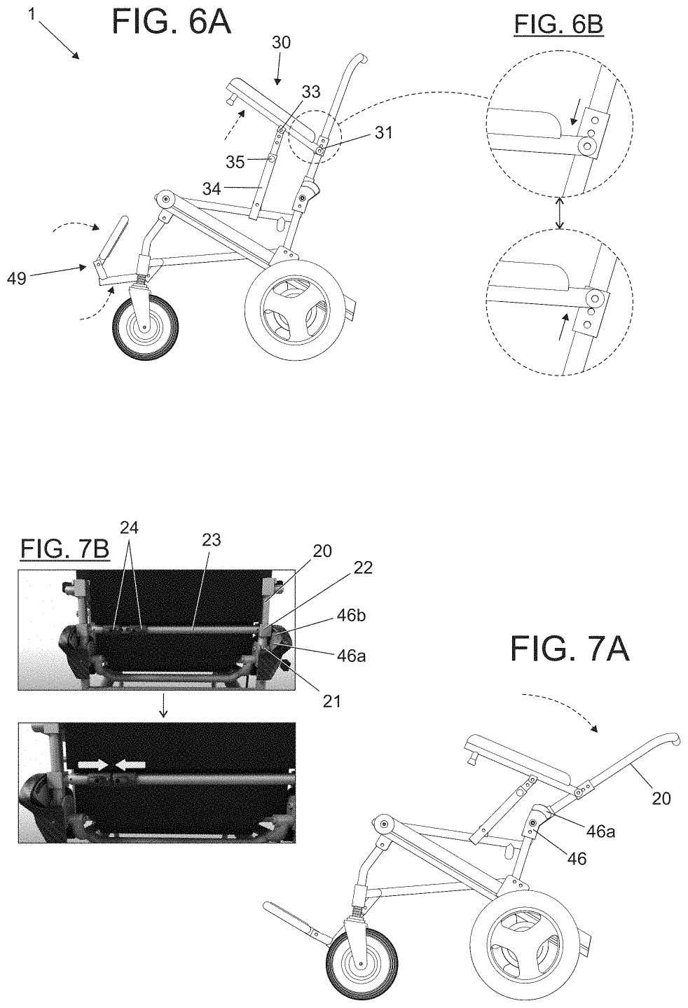

Thus, as illustrated in FIGS. 6A and 6B, the chair (1) allows the height adjustment of its armrest (30), both tilting and fixed. The tilting adjustment takes place through the release of the locking pin (35) that releases the telescopic component (34) to adjust, supported by the lower bearing (33), up or down the height of the armrest (30) that tilts from its eye (31). Once the ideal height has been found, the locking pin (35) can be locked/released to keep the armrest (30) in position. The fixed adjustment {detail C} is done by removing the pin/bolt from the eye (31), releasing it from the adjustment terminal (25) of the backrest structure (20), to be inserted again in a new hole in said terminal (25) at the desired height.

As shown in FIGS. 7A and 7B, the backrest structure (20) and therefore the backrest of the chair (1) can be adjusted to the preferred inclination for the user's back. To do so, it is enough to activate the pressure lock (24) of the crossbar (23) {detail D} to release its pins from the housings (46b) of the side ratchets (46a) where they are inserted. Thus, the backrest structure (20) is free to be tilted forwards or backwards, through the eyelets (21) fixed by axis in the union terminal (46) of the lower structure (40). When the desired inclination is found, it is enough for the pressure lock (24) to be released to automatically insert its pins into the new housings (46b) of the ratchets (46a). The tilting movement is naturally accompanied by the armrest (30), provided by its union by axes and without the need for specific adjustments.

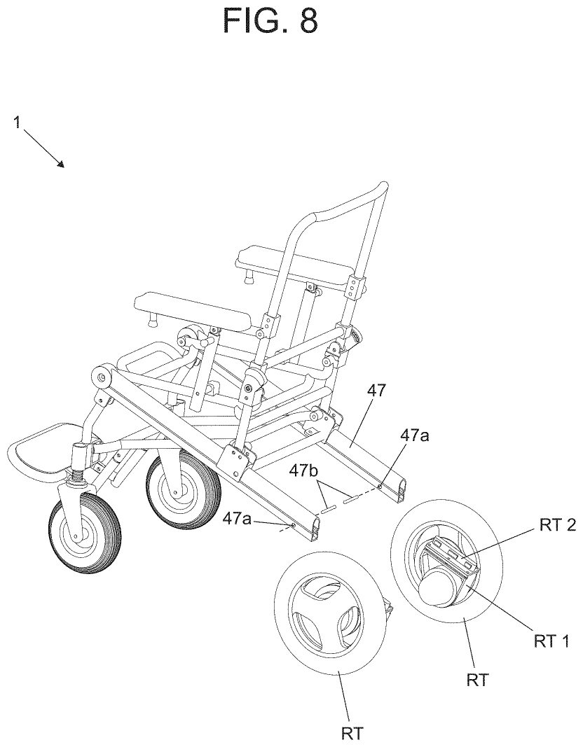

As shown in FIG. 8, the rear wheels (RT) can be removed from the chair (1) to be changed and/or to reduce the weight and volume of the chair (1) when transporting or storing it. To do so, it is sufficient to remove the threaded pins (47b) from the side holes (47a) of the rail profiles (47), releasing the coupling keys (RT2) of the aforementioned wheels (RT) from within the latter, which can then be removed of the lower quarters (not shown). Of course, the rear wheels (RT) can be re-attached to the chair (1) by the reverse action. In these rear wheels (RT) pull-out and plug-in actions, their power supply plugs can be easily disconnected and connected to the chair's rechargeable battery plugs.

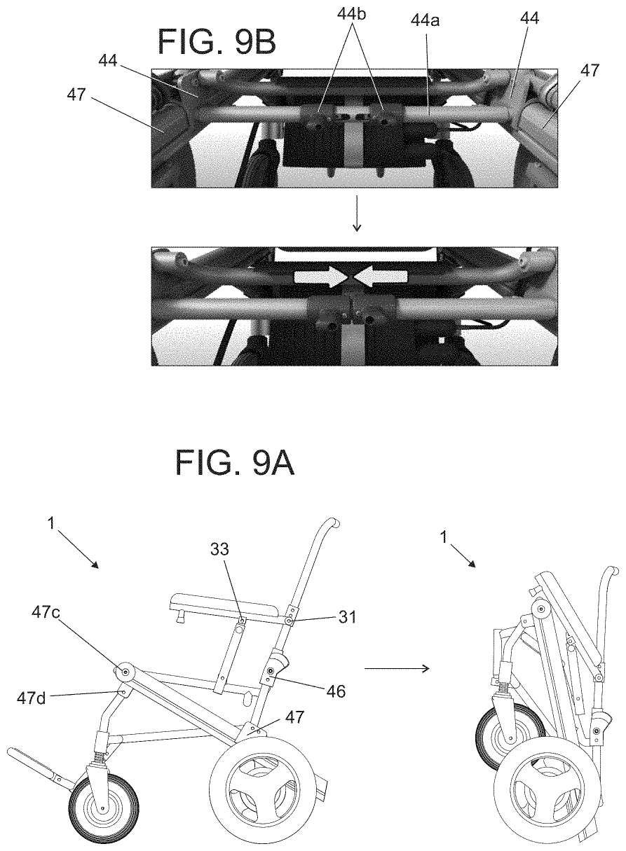

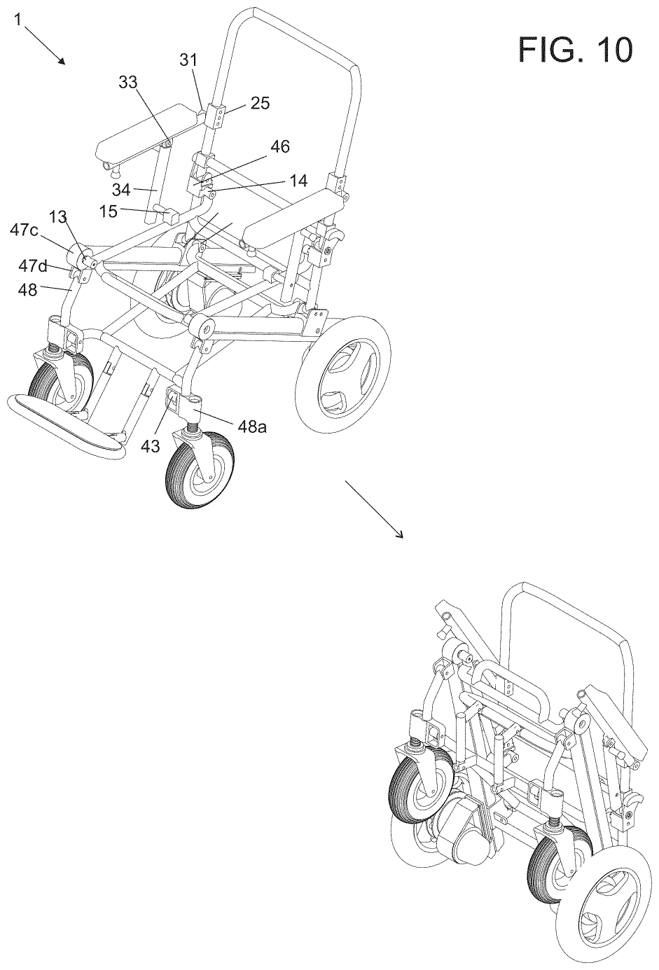

As shown in FIGS. 9A and 9B, the chair (1) can be fully compacted in a single system to facilitate and allow its transport and storage in small places. To do so, it is enough for the pressure locks (44b) of the beam (44a) to be activated, releasing their pins from inside the trolleys (44) and, thus, releasing the trolleys (44) to run along the rail profiles (47). In this action, both the seat structure (10) and the backrest structure (20) are articulated at the union terminal (46), allowing the approximation and, therefore, the compaction of the chair (1), accompanied by the front wheels (RF) and by the armrest (30) equally articulated by their bearings and union eyes. Thus, in its compressed format, as illustrated in FIGS. 9A and 10, the chair (1) assumes a considerably smaller volume, allowing it to be inserted into reduced spaces such as trunks, closets and corners, facilitating its transport and storage.

Optionally, the wheelchair (1) can be designed with electronic actuators to promote the compaction system, described above, in an automated way, allowing the compaction action to be carried out by the user.

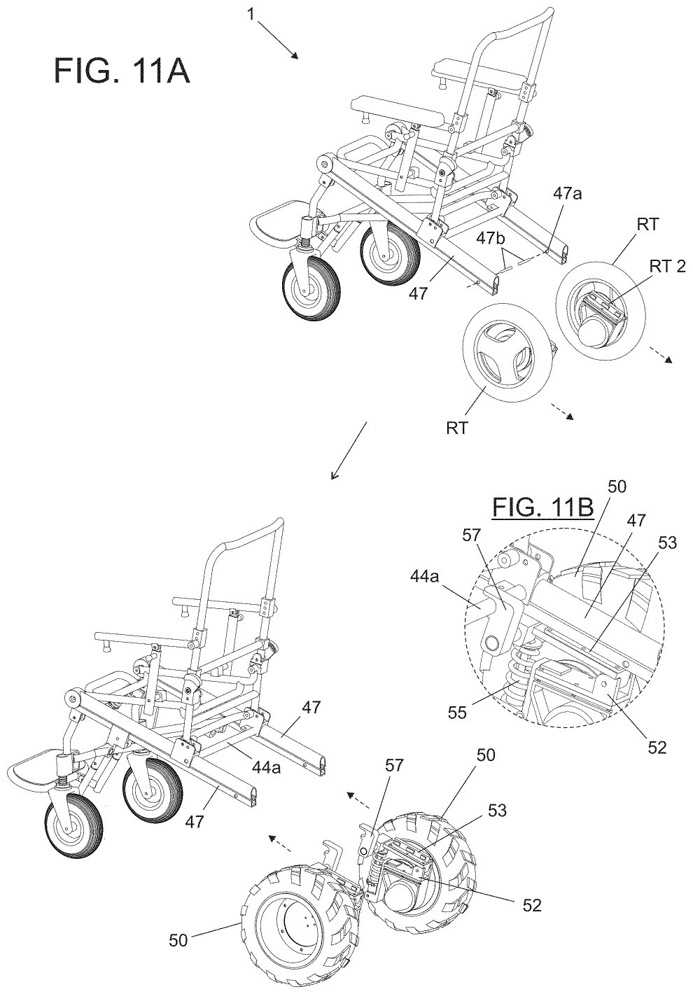

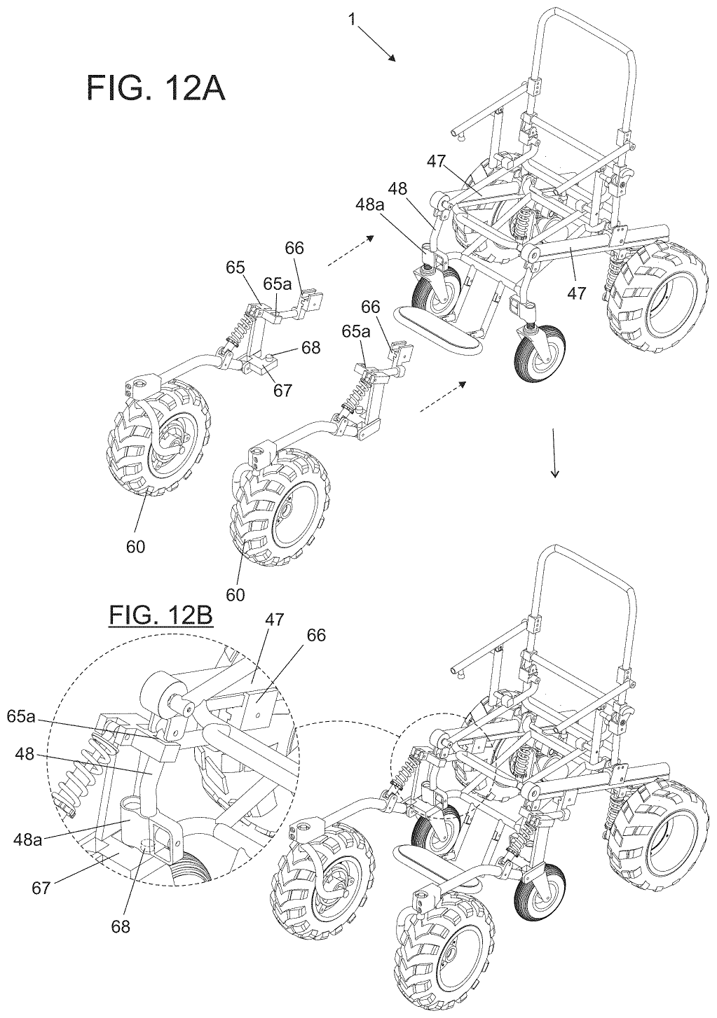

To use the off-road kit (2), as shown in FIGS. 11A, 11B, 12A and 12B, it is enough that the rear wheel (RT) is removed from the chair (1) according to the method explained above so that the kit can be installed easily and fast.

With the rear wheels (RT) of the chair (1) removed, the user must replace them with the rear wheels (50) from the kit (2) {FIG. 11A}, so that the coupling key (53) of the bearing (52) of each wheel (50) is fitted in the respective lower housing of the rail profile (47), where the previous rear wheel (RT) was located. Thus positioned, the threaded pins (47b) must be inserted into the side holes (47a) of the rail profiles (47) to lock and block their exit. At the same time, during the fitting of the wheel (50), the support sleeve (57) must be directed and engaged in the beam (44a) of the lower support structure (40) of the chair (1), embracing it and thus offering the correct fixation of the rear wheels (50) and the efficient operation of its damping terminal (56). Therefore, the user must connect their power supply plug to the wheelchair's battery plug (1).

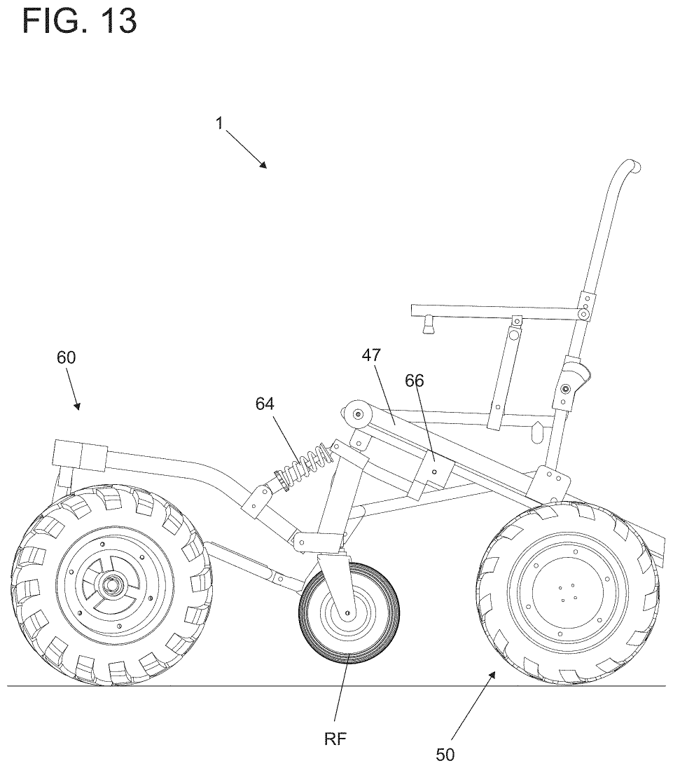

Next, the user must couple the front wheels (60) of the kit (2), so that each wheel (60) has its clamp-type terminal (66) engaged in the respective rail profile (47), at the same time as the recess (65a) of the joint piece (65) receives and embraces the tubular profile (48) of the lower support structure (40) of the chair (1), and at the same time as the male pin (68) of the lateral extension (67) is inserted in the proper housing (48b) of the coupling terminal (48a) of said tubular profile (48). In this way, this off-road front wheel structure (60) will suspend the front portion of the chair (1), keeping the front wheel (RF) in elevation and therefore replacing its support. In this position, properly engaged and fitted, the clamp terminal (66) must be locked by its lock (not shown), which can be a lever, pin, threaded pin, etc., thus keeping the off-road front wheel (60) stable and safe, as shown in FIG. 13.

In this configuration, assembled with the off-road kit (2), the wheelchair (1) gains the locomotion properties of off-road vehicles, thus being able to be used in different, inhospitable, rough, muddy and/or wet terrains safely and without the complications of the common wheelchairs on the market.

1. A motorized wheelchair, controlled by electronic control, having a structure adapted to receive a series of adjustments and an off-road type kit to allow its locomotion through differentiated, rough and inhospitable terrains, said wheelchair formed by a tubular metallic structure composed of a seat structure, a backrest structure, an armrest and a lower support structure equipped with a front wheel and rear wheel, wherein:
the seat structure being formed by a pair of parallel side tubes joined by welding to a pair of perpendicular tubes, where each parallel tube adopts a front eye at its front end, a rear eye at its rear end and an intermediate bearing;
the backrest structure being formed by an inverted U-bent tube whose ends adopt an eyelet each, receiving above each eyelet a pair of union terminals that support a crossbar equipped with pressure locks whose locking pins cross laterally the backrest structure, where above the union terminals, approximately in the center of the parallel arms of the U-tube of the structure, this receives a opposing pair of adjustment terminals hollowed out by at least three holes;
the armrest being two identical and opposing structures, positioned one on each side of the chair, each armrest being formed by a horizontal tubular arm, whose rear end receives an eye with which is fixed by axis to one of the holes of one of the adjustment terminals, allowing tilting movement, where each tubular arm receives a lower locking pin near its front end and a lower bearing in its central portion, with the lower bearing supporting the end of a telescopic component for height adjustment, equipped with a locking pin and lowerly joined by an axis to the intermediate bearing of the seat structure, in which one of the tubular arms the support for an electronic control is introduced and locked by the lower locking pin, said electronic control able to be removed and fitted to the opposite arm when necessary;
the lower support structure being formed by a tubular frame joined by a rear tube and a front tube, both curved in C and provided with an eye at each end, each eye opposed to the rear tube fixed by axis to the bearing of a trolley, whose said bearing supports, also by axis, the eye of a vertical support bar, the pair of support bars being opposed joints joined and secured centrally by a crossbar, where the upper end of each support bar adopts a union terminal composed of two independent bearings (one lower and one upper) and a side ratchet with five housings, with the lower bearing receiving and fixing the rear eye of the parallel tube of the seat structure on both sides, joining it in a tilting manner to the lower support structure and that the upper bearing fixes the eyelet of the backrest structure by axis, so each side, joining it equally in a tilting way, where in this position the pins of the pressure locks of the crossbar are housed in one of the housings of the side ratchet, supporting the backrest structure in a vertical position;
the seat frame and the back frame being hingedly joined to the lower support structure, the pair of opposing trolleys being joined by a beam provided with pressure locks whose locking pins point inside the trolleys, where said trolleys are slidably fitted to a pair of inclined rail profiles, which receive a lower housing near each rear end (not shown) with side hole for threaded pin and, next to each front end, an eye that joins the rail profile by axis to the front eye of the seat structure, and next to the eye each rail profile incorporates a lower bearing that fixes a vertical tubular profile supported by a coupling terminal in its own housing by axis, which receives the front wheel of the chair and is attached by axis to the eye of the front tube, where centrally the front tube extends a pair of arms that support by axis a footrest articulated and adjustable;
the rear wheels have their own electric motor with a plug for electrical supply connected to the rechargeable battery of the chair, where each rear wheel has its axis of rotation supported by a bearing whose surface support adopts a coupling key coincident with the lower housing of the rails of the lower support structure, where the rear wheels are removable and locked by the threaded pin, inserted in the side hole of the rail that supports it;
the electronic control that controls the wheelchair has at least power increase and decrease commands with LED display, on and off button, horn, battery charge LED display and the ‘joystic’ or control of the chair's movements and acceleration.

2. The motorized wheelchair of claim 1, wherein the lower support structure supports in its lower portion the rechargeable battery and the general electronic control center.

3. The motorized wheelchair of claim 1, wherein includes a remote control and/or an application for smartphones communicating with its electronic control center to control the chair remotely.

4. An attachable off-road kit to the wheelchair, formed by a pair of rear wheels with off-road or mixed tires with its own rotating motor, and a pair of front wheels with off-road or mixed tires, where each off-road rear wheel extends from its motor an electrical supply cable equipped with a connection plug coincident with the wheelchair battery cable plug, said off-road kit wherein:
each rear wheel having the rotation motor enclosed and protected by a rigid cover housed in a bearing, of which one end receives by axle a metal plate where a coupling key is fixed, which coincides with the shape of the lower housing of the rails of the support structure of the chair, and frontally the bearing incorporates a frontal support where a damper or shock absorber assembly is installed, whose upper damping terminal is welded to the front face of the metal plate containing the coupling key and extends laterally a support sleeve;
each front wheel having its axle connected to the tubular arm of a structural frame that supports, above the wheel, an axle connected to the bearing of an extension arm which, in turn, is supported in a damper or shock absorber assembly fixed to a support that extends a joint piece with a recess above and projects a clamp-type terminal equipped with a lock and, below, receiving a lateral extension provided with male pin of shape coincident with the housing of the coupling terminal of the chair.

5. The attachable off-road kit of claim 4, wherein includes sports seat belt for adaptation to the chair, an additional battery and a cover for storage and transport of the said kit.

6. An adjustment system of the wheelchair to allow the height adjustment of its armrest, both tilting and fixed, adjusting the inclination of the backrest of the chair and removal of the rear wheel, wherein:
the tilting adjustment of the armrest be done through the release of the locking pin that releases the telescopic component to adjust, supported by the lower bearing, up or down the height of the armrest that swings from its eye;
the fixed adjustment of the armrest takes place by removing the pin/bolt from the eye, releasing it from the adjustment terminal of the backrest structure to be inserted again in a new hole in said terminal at the desired height;
the adjustment of the backrest structure and, therefore, the backrest of the chair occurs with the activation of the pressure lock of the crossbar releasing its pins from the housings of the side ratchets, the backrest structure being free to be tilted forwards or backwards, through the eyelets fixed by axis in the union terminal of the lower support structure, being the pressure locks released to insert automatically their pins in the new housings when the desired position is found;
the removal of the rear wheels takes place when the threaded pins are removed from the side holes of the rail profiles, releasing the coupling keys of said wheels from within the latter, which can then be removed from the lower housings by disconnecting their power plugs from the chair's rechargeable battery.

7. A compaction system of the chair to its fully compaction in a single system to reduce its volume and facilitate and allow its transport and storage in small places, wherein the activation of the pressure locks of the beam releases its pins from inside the trolleys and thus releasing the trolleys to run along the rail profiles, where both the seat structure and the backrest structure are articulated at the union terminal, allowing the approximation and, therefore, the compaction of the chair, accompanied by the front wheels and the armrest also articulated by their bearings and connecting eyes.

8. The compaction system of claim 7, wherein, optionally, the wheelchair is designed with electronic actuators to promote the compaction system automatically.

9. An assembly system of the off-road kit to the wheelchair, after removal of the rear wheel, wherein:
the coupling key of the bearing of each wheel is fitted into the respective lower housing of the rail profile, the threaded pins being inserted into the side holes of the rail profiles for locking, where in parallel, during the fitting of the wheel, the support sleeve is directed and engaged in the beam of the support structure of the wheelchair, hugging it, being the power supply plug then connected to the wheelchair's battery plug;
coupling the front wheels of the kit, so that each wheel has its clamp-type terminal engaged in the respective rail profile, at the same time as the recess of the joint piece receives and embraces the tubular profile of the support structure of the wheelchair, and at the same time the male pin of the lateral extension is inserted in the proper housing of the coupling terminal of the aforementioned tubular profile, where the front wheel structure will suspend the front portion of the wheelchair, keeping the front wheel in lifting, replacing its support, and in this position the clamp terminal being locked by its lever, pin, threaded pin, or other lock type.
